(19) United States
(12) Patent Application Publication
(10) Pub. No.: US 2010/0134322 A1
(43) Pub. Date: Jun. 3, 2010

(54) APPARATUS AND METHOD FOR DETECTING VEHICLES

(75) Inventors: Jaejun Yoo, Daejeon (KR); Kyung Bok Sung, Daejeon (KR); Do Hyun Kim, Daejeon (KR); Byung Tae Jang, Daejeon (KR); Jeong Dan Choi, Daejeon (KR); Jungsook Kim, Daejeon (KR); Jeong Ah Jang, Daejeon (KR); Kyeong Tae Kim, Daejeon (KR); Jae Han Lim, Daejeon (KR); Jong Hyun Park, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/535,883

(22) Filed: Aug. 5, 2009

(30) Foreign Application Priority Data
Dec. 2, 2008 (KR) 10-2008-0121029
Apr. 6, 2009 (KR) 10-2009-0029321

(51) Int. Cl. G08G 1/01

(52) U.S. Cl. 340/935

(57) ABSTRACT

An apparatus for detecting a vehicle includes a magnetic sensor that continuously obtains a magnetic signal varied due to movement of a vehicle; a gradient detecting unit that detects a gradient of the magnetic signal based on the obtained magnetic signal; and a vehicle status transitioning unit that generates status transition information of the vehicle based on the detected gradient. The apparatus further includes a vehicle coming-in/out determining unit that determines coming-in or coming-out of the vehicle based on the vehicle status transition information.

### CROSS-REFERENCE(S) TO RELATED APPLICATIONS

The present invention claims priority of Korean Patent Application No. 10-2008-0121029, filed on Dec. 2, 2008 and Korean Patent Application No. 10-2009-0029321, filed on Apr. 6, 2009, which are incorporated herein by reference.

### FIELD OF THE INVENTION

The present invention relates to a system for detecting vehicles, and more particularly, to an apparatus and method for detecting vehicles, which is capable of generating vehicle status transition information by detecting a gradient of a magnetic signal continuously obtained from a magnetic sensor depending on whether or not a vehicle is present, and correctly judging coming in/out of the vehicle based on the vehicle status transition information.

### BACKGROUND OF THE INVENTION

Recently, various method and systems have been proposed which detect vehicles and calculate their speed, including, for example, a loop detector, an image detector, a laser sensor, an ultrasonic sensor and the like.

A vehicle detection method using a magnetic sensor as one of these detectors is to extract information on vehicle movement by detecting variation of an earth magnetic field caused by the vehicle movement, with various algorithms proposed to process a magnetic signal for vehicle detection using the magnetic sensor.

Specifically, in most of conventional vehicle detection methods using a magnetic sensor, a value of a magnetic signal obtained by the magnetic sensor depending on the presence or not of a vehicle is compared with a preset baseline, and the vehicle is considered to be detected if the magnetic signal value becomes larger or smaller than the baseline.

However, in such conventional vehicle detection methods using a magnetic sensor, which determine the presence or not of vehicles by comparing the magnetic signal value obtained by the magnetic sensor with the preset baseline, if the baseline of the magnetic sensor is changed by any environmental factors of the magnetic sensor, such as temperature, humidity and the like, a threshold value to allow for determination about the presence or not of vehicles has to be reset properly. If dynamic setting of the threshold value can not be supported, this may result in incorrect vehicle detection.

### SUMMARY OF THE INVENTION

Therefore, the present invention provides an apparatus and method for detecting vehicles, which is capable of generating vehicle status transition information by detecting a gradient of a magnetic signal continuously obtained from a magnetic sensor depending on the presence or not of vehicle, and making correct determination about vehicle detection and situation of entrance/exit of vehicle based on the vehicle status transition information.

In accordance with an aspect of the present invention, there is provided an apparatus for detecting a vehicle, including: a magnetic sensor that continuously obtains a magnetic signal varied due to movement of a vehicle; a gradient detecting unit that detects a gradient of the magnetic signal based on the obtained magnetic signal; a vehicle status transitioning unit that generates status transition information of the vehicle based on the detected gradient; and a vehicle coming-in/out determining unit that determines coming-in or coming-out of the vehicle based on the vehicle status transition information.

In accordance with another aspect of the present invention, there is provided a method of detecting a vehicle, including the steps of: continuously obtaining a magnetic signal varied due to movement of a vehicle using a magnetic sensor; detecting a gradient of the magnetic signal based on the obtained magnetic signal; generating status transition information of the vehicle based on the detected gradient; and determining coming-in or coming-out of the vehicle based on the vehicle status transition information.

The present invention provides a vehicle detecting method using a magnetic sensor, which is capable of detecting the presence or not of vehicle with high reliability irrespective of variation of a magnetic signal due to environments of the magnetic sensor, such as temperature, humidity and the like, by detecting a gradient of the magnetic signal generated in response to vehicle movement and continuously obtained from the magnetic sensor. In addition, by generating vehicle status transition information based on vehicle On and Off signals obtained from the gradient of the vehicle and determining first coming-in and last coming-out of the vehicle based on the generated vehicle status transition information, it is possible to determine coming-in/out of the vehicle with higher precision.

### BRIEF DESCRIPTION OF THE DRAWINGS

The above and other objects and features of the present invention will become apparent from the following description of preferred embodiments, given in conjunction with the accompanying drawings, in which:

FIGS. 1A to 1C show a concept of detecting a gradient of a magnetic signal for vehicle detection in accordance with an embodiment of the present invention;

FIG. 2 is a view showing a concept of detecting a vehicle based on a threshold value for a gradient of a magnetic signal in accordance with the embodiment of the present invention;

FIG. 3 illustrates a vehicle status transition based on a gradient of a magnetic signal in accordance with the embodiment of the present invention;

FIG. 4 is a block diagram showing a configuration of a vehicle detection apparatus in accordance with the embodiment of the present invention; and

FIG. 5 is a control flow chart showing a vehicle detecting process using a gradient of a magnetic signal in a vehicle detection apparatus in accordance with the embodiment of the present invention.

### DETAILED DESCRIPTION OF THE EMBODIMENTS

Hereinafter, preferred embodiments of the present invention will be described in detail with reference to the accompanying drawings. In the following detailed description of the present invention, concrete description on related functions or constructions will be omitted if it is deemed that the functions and/or constructions may unnecessarily obscure the gist of the present invention. Terminologies defined and used in the specification in consideration of functions of the present invention may be varied in their meaning depending on user or operator's intention, custom or the like. Therefore, such terminologies should be defined based on the whole contents described in the specification.

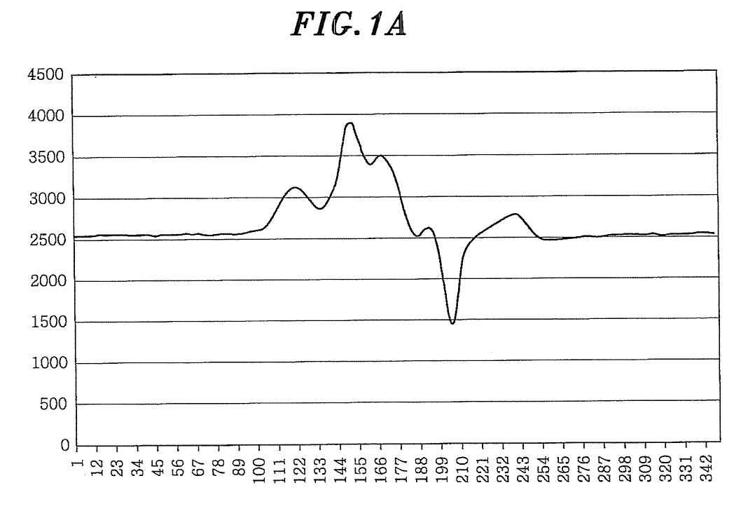

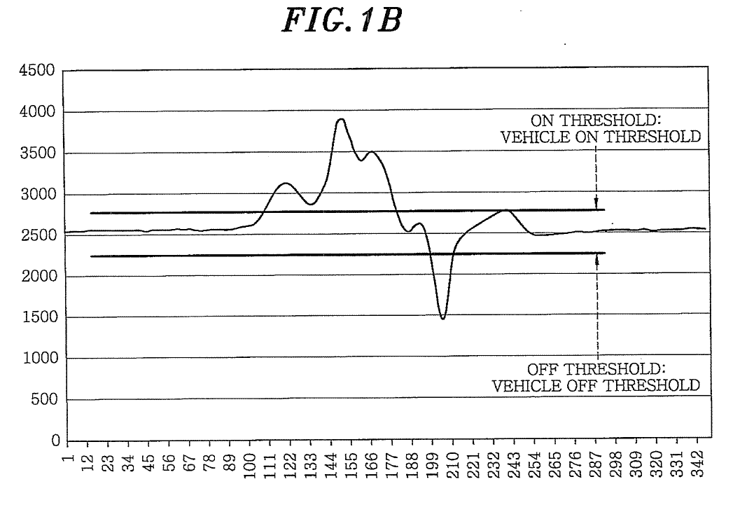

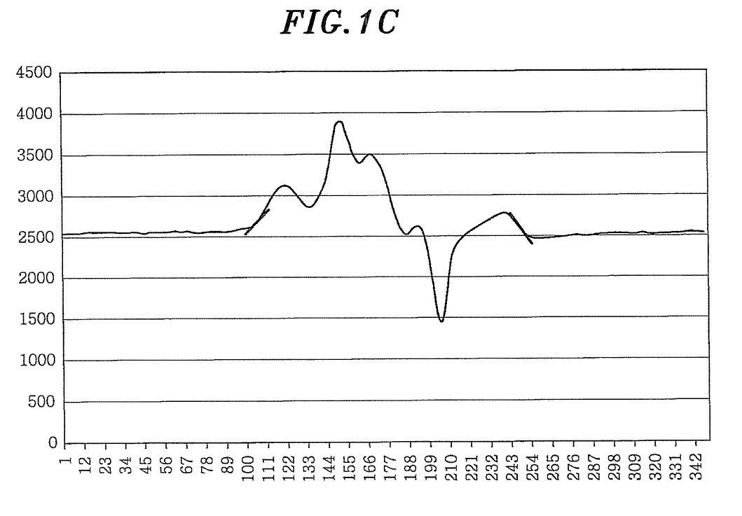

FIGS. 1A to 1C show examples of magnetic signal gradient detection for detecting a vehicle by detecting a gradient of a magnetic signal continuously obtained from a magnetic sensor according to an embodiment of the present invention.

First, FIG. 1B shows how to detect the presence or not of a vehicle by comparing a value of a magnetic signal obtained from a magnetic sensor with a preset threshold value in a conventional vehicle detecting method using a magnetic sensor. If a magnetic signal as shown in FIG. 1A is input from the magnetic sensor, a vehicle On signal indicating the presence of a vehicle or a vehicle Off signal indicating the absence of a vehicle is generated on the basis of the preset threshold value for vehicle detection, as shown in FIG. 1B.

However, as described earlier, in such a conventional vehicle detecting method using the threshold value, the threshold value set in the magnetic sensor may be varied depending on environments of the magnetic sensor, such as humidity, temperature and the like, and if the threshold value can not be dynamically adjusted for such variation from time to time, this may result in incorrect vehicle detection.

For the purpose of overcoming such a problem, in the present invention, a gradient of a magnetic signal is measured and the presence or not of vehicle is detected when the gradient is changed over a particular threshold value, as shown in FIG. 1C.

That is, in the vehicle detecting method of the present invention based on the gradient of the magnetic signal, a degree of continuous variation of the magnetic signal is measured, and the presence or not of vehicle is determined based on the measured degree of variation, which results in more correct vehicle detection without a problem of variation of the threshold value due to the environments of the magnetic sensor, unlike the conventional method.

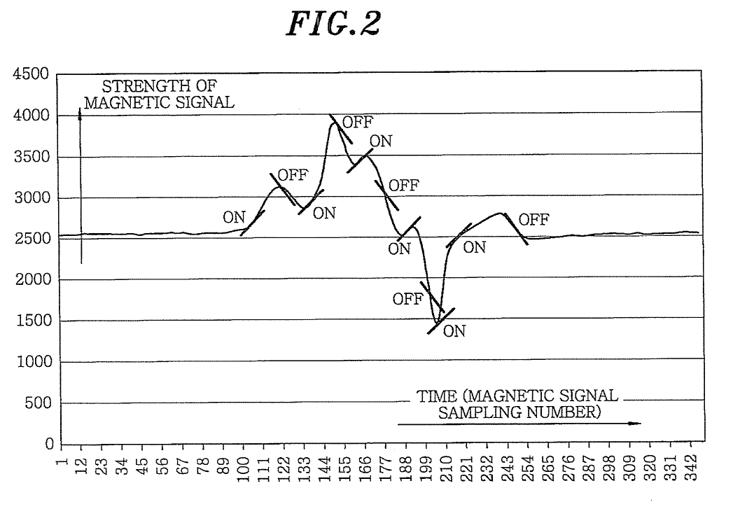

FIG. 2 shows an example of determining the presence or not (On or Off) of vehicle using a gradient of a magnetic signal according to an embodiment of the present invention. As shown in FIG. 2, when a magnetic signal gradient value beyond a threshold value is detected in a graph showing variation of a magnetic signal continuously obtained from a magnetic sensor by a vehicle, the presence or not (On or Off) vehicle can be determined.

Through such determination about vehicle On and Off, first vehicle On determination can be utilized as point information to detect entrance of a vehicle, while last vehicle Off determination can be utilized as point information to detect exit of a vehicle. In this manner, when a plurality of vehicle On and Off signals is detected from the variation of the continuous magnetic signal for vehicle detection, a meaningful vehicle On or Off signal is selected from the detected plurality of vehicle On and Off signals to determine coming-in or coming-out of the vehicle from.

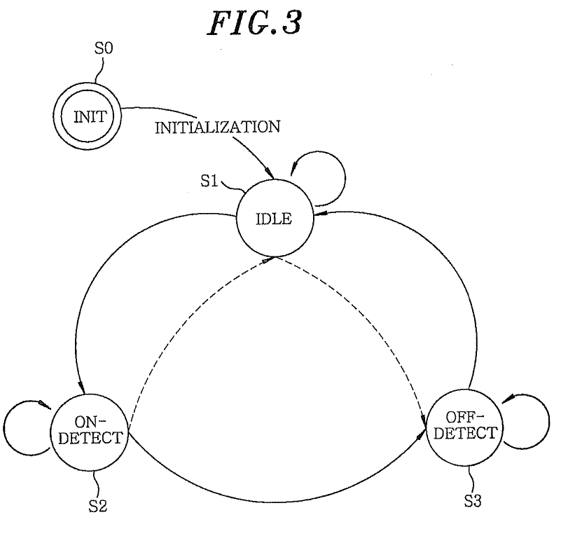

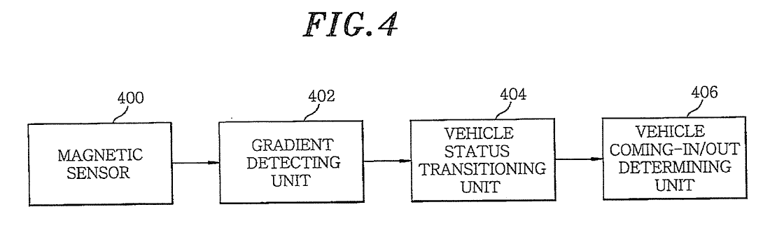

FIG. 3 is a vehicle statuses transition diagram from which the status of vehicle can be determined according to a vehicle On or Off signal, and FIG. 4 is a block diagram showing a configuration of a vehicle detection apparatus for determining coming-in and out of a vehicle based on the vehicle status transition diagram.

Hereinafter, a vehicle coming-in/out determining process using a gradient of a magnetic signal according to an embodiment of the present invention will be described with reference to FIGS. 3 and 4.

First, referring to FIG. 3, a status transition diagram for finding vehicle On and Off signals related to the coming-in and coming-out of the vehicle in one magnetic signal includes a non-initialization status (S0) in which nothing is performed, an idle status (S1) in which no vehicle On and Off signal is detected although a magnetic sensor 400 is operated to collect a magnetic signal, a vehicle On status (S2) in which a last vehicle On signal of continuous vehicle On/Off signals is detected, and a vehicle Off status (S3) in which a last vehicle Off signal of the continuous vehicle On/Off signals is detected.

Specifically, a vehicle status transitioning unit 404 transitions vehicle status into the idle status (S1) if no vehicle On and Off signal is detected while a magnetic signal starts to be collected from the magnetic sensor in the non-initialization status (S0) in which no magnetic signal is collected, based on a magnetic signal gradient detected from a gradient detecting unit 402. At this time, the gradient detecting unit 402 detects magnetic signal gradients from the magnetic signal continuously obtained from the magnetic sensor 400, compares the detected gradients with a threshold value, detects a gradient beyond the threshold value, and provides the detected gradient beyond the threshold value to the vehicle status transitioning unit 404.

At this time, the vehicle status transitioning unit 404 recognizes an absolute value of a gradient detected from the gradient detecting unit 402 as a vehicle On signal if the absolute value is larger than the threshold value and the gradient has a positive value, and recognizes the absolute value as a vehicle Off signal if the absolute value is larger than the threshold value and the gradient has a negative value.

Subsequently, if a vehicle On signal is detected in the idle status (S1), the vehicle status transitioning unit 404 stores a point when the vehicle On signal is generated, and transitions vehicle status into the vehicle On status (S2) in which the last vehicle On signal is detected. At this time, if a vehicle On signal is again detected in the status (S2) in which the last vehicle On signal is detected, the vehicle status remains unchanged.

On the other hand, if a vehicle Off signal is detected, the vehicle status transitioning unit 404 transitions the vehicle status into the vehicle Off status (S3) in which the last vehicle Off signal is detected. Subsequently, if a vehicle On signal is again detected in the status (S3) in which the last vehicle Off signal is detected, the vehicle status transitioning unit 404 again transitions the vehicle status into the vehicle On status (S2) in which the last vehicle On signal is detected. On the other hand, if a vehicle Off signal is detected, the vehicle status remains unchanged.

In the meantime, during the repetition of the vehicle On status (S2) and the vehicle Off status (S3), if vehicle On or vehicle Off is not detected until a certain period of time elapses in the vehicle Off status (S3) in which the last vehicle Off signal is detected, the vehicle status transitioning unit 4040 determines that the vehicle comes out completely, and transitions the vehicle status into the idle status (S1) in which no vehicle On and Off signal is detected.

Then, a vehicle coming-in/out determining unit 406 determines whether the vehicle comes in or out, based on the vehicle status transition information from the vehicle status transitioning unit 404. Specifically, based on the vehicle status transition information provided from the vehicle status transitioning unit 404, the vehicle coming-in/out determining unit 406 determines a point when the vehicle status is first transitioned into the vehicle On status (S2) to be a vehicle coming-in point, determines a point when the vehicle status is transitioned from the vehicle Off status (S3) into the idle status (S1) to be a vehicle coming-out point, and decides vehicle coming-in/out time.

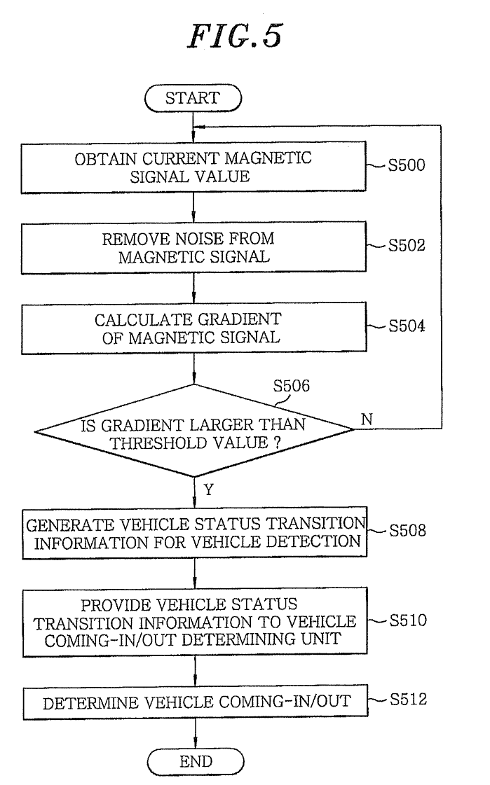

FIG. 5 is a control flow chart showing a vehicle detecting process using a gradient of a magnetic signal in a vehicle detection apparatus according to an embodiment of the present invention. Hereinafter, an embodiment of a vehicle detecting process will be described in detail with reference to FIGS. 3 to 5.

First, when vehicle detection using a magnetic signal starts, the magnetic sensor obtains a current magnetic signal value every given sampling period (S500). At this time, the magnetic sensor calculates a current magnetic signal value again by averaging N past magnetic signal values given as factors of an algorithm to remove a noise value existing in the magnetic signal. This noise removal is for raising the precision of vehicle detection. Although this embodiment employs the method of averaging the N past magnetic signal values, this embodiment may employ other methods in various ways.

In this manner, once the magnetic signal with noise substantially removed is obtained using the averaging, the obtained magnetic signal is applied from the magnetic sensor 400 to the gradient detecting unit 402. Then, the gradient detecting unit 402 obtains a gradient of the magnetic signal by comparing the current magnetic signal value with the previous M-th magnetic signal value (S504). Here, a value M may be selectively set depending on a place where the magnetic sensor 400 is used, or may be used as a tuning point for performance to adjust sensitivity of the magnetic sensor 400.

Once the gradient is obtained, the gradient detecting unit 402 checks whether or the obtained gradient of the magnetic signal exceeds a preset threshold value (S506). If it is checked that the obtained gradient does not exceed the threshold value, the gradient detecting unit 402 calculates a gradient of a newly input magnetic signal repeatedly (S500 to S504). If it is checked that the obtained gradient of the magnetic signal exceeds the threshold value, information of the gradient is provided to the vehicle status transitioning unit 404.

Then, the vehicle status transitioning unit 404 determines a vehicle On or Off signal based on the gradient information provided from the gradient detecting unit 402, generates vehicle status transition information for vehicle detection (S508), and provides the generated vehicle status transition information to the vehicle coming-in/out determining unit 406 (S510).

Here, as described above, the vehicle status transition information generated in the vehicle status transitioning unit 404 includes a non-initialization status (S0) in which nothing is performed, an idle status (S1) in which no vehicle On and Off signal is detected although a magnetic sensor 400 is operated to collect a magnetic signal, a vehicle On status (S2) in which a last vehicle On signal of continuous vehicle On/Off signals is detected, that is, the presence of vehicle is detected, and a vehicle Off status (S3) in which a last vehicle Off signal of the continuous vehicle On/Off signals is detected, that is, the presence of vehicle is not detected.

Then, the vehicle coming-in/out determining unit 406 determines whether the vehicle comes in or out, based on the vehicle status transition information from the vehicle status transitioning unit 404 (S512). Specifically, based on the vehicle status transition information provided from the vehicle status transitioning unit 404, the vehicle coming-in/out determining unit 406 determines a point when the vehicle status is first transitioned into the vehicle On status (S2) to be a vehicle coming-in point, determines a point when the vehicle status is transitioned from the vehicle Off status (S3) into the idle status (S1) to be a vehicle coming-out point, and decides vehicle coming-in/out time.

As described above, the present invention provides a vehicle detecting method using a magnetic sensor, which is capable of detecting the presence or not of vehicle with high reliability irrespective of variation of a magnetic signal due to environments of the magnetic sensor, such as temperature, humidity and the like, by detecting a gradient of the magnetic signal generated in response to vehicle movement and continuously obtained from the magnetic sensor. In addition, by generating vehicle status transition information based on vehicle On and Off signals obtained from the gradient of the vehicle and determining first coming-in and last coming-out of the vehicle based on the generated vehicle status transition information, it is possible to determine coming-in/out of the vehicle with higher precision.

While the invention has been shown and described with respect to the preferred embodiments, it will be understood by those skilled in the art that various changes and modifications may be made without departing from the scope of the invention as defined in the following claims.

What is claimed is:

1. An apparatus for detecting a vehicle, comprising:
a magnetic sensor that continuously obtains a magnetic signal varied due to movement of a vehicle;
a gradient detecting unit that detects a gradient of the magnetic signal based on the obtained magnetic signal;
a vehicle status transitioning unit that generates status transition information of the vehicle based on the detected gradient; and
a vehicle coming-in/out determining unit that determines coming-in or coming-out of the vehicle based on the vehicle status transition information.

2. The apparatus of claim 1, wherein the vehicle status transition information includes a vehicle On status in which the magnetic signal increases, a vehicle Off status in which the magnetic signal decreases, and an idle status in which the magnetic signal neither increases nor decreases.

3. The apparatus of claim 2, wherein the vehicle status transitioning unit compares the gradient of the magnetic signal with a preset threshold value and determines status of the vehicle to be transitioned if the gradient is larger or smaller than the threshold value.

4. The apparatus of claim 3, wherein the vehicle status transitioning unit transitions the vehicle status into the vehicle On status if the gradient is larger in an absolute value than the threshold value and has a positive value and transitions the vehicle status into the vehicle Off status if the gradient is larger in an absolute value than the threshold value and has a negative value.

5. The apparatus of claim 4, wherein the vehicle status transitioning unit transitions the vehicle status into the idle status if the vehicle Off status lasts during a predetermined period of time.

6. The apparatus of claim 2, wherein the vehicle coming-in/out determining unit determines a point when the vehicle status is first transitioned into the vehicle On status to be a vehicle coming-in point.

7. The apparatus of claim 6, wherein, if the vehicle status is transitioned from the vehicle Off status into the idle status, the vehicle coming-in/out determining unit determines a last vehicle Off point to be a point when the vehicle lastly comes out.

8. A method of detecting a vehicle, comprising:
continuously obtaining a magnetic signal varied due to movement of a vehicle using a magnetic sensor;
detecting a gradient of the magnetic signal based on the obtained magnetic signal;
generating status transition information of the vehicle based on the detected gradient; and
determining coming-in or coming-out of the vehicle based on the vehicle status transition information.

9. The method of claim 8, wherein the gradient is compared with a preset threshold value and the vehicle is detected if the gradient is larger than the threshold value.

10. The method of claim 8, wherein the vehicle status transition information includes an idle status in which the vehicle is not detected, a vehicle On status in which the presence of the vehicle is detected based on the magnetic signal, and a vehicle Off status in which the absence of the vehicle is detected based on the magnetic signal.

11. The method of claim 10, wherein the magnetic signal is collected from the magnetic sensor, and the vehicle status is transitioned into the idle status if the gradient of the magnetic signal is smaller than a preset threshold value.

12. The method of claim 11, wherein the magnetic signal is collected from the magnetic sensor, and the vehicle status is transitioned into the vehicle On status if the gradient is larger in an absolute value than the threshold value and has a positive value.

13. The method of claim 12, wherein the vehicle status is transitioned into the vehicle Off status if the gradient is larger in an absolute value than the threshold value and has a negative value.

14. The method of claim 10, wherein said determining coming-in or coming-out of the vehicle comprises determining a point when the vehicle status is first transitioned into the vehicle On status to be a vehicle coming-in point.

15. The method of claim 10, wherein the step of determining coming-in or coming-out of the vehicle comprises determining a last vehicle Off point to be a point when the vehicle lastly comes out if the vehicle status is transitioned from the vehicle Off status into the idle status.
